(19) United States
(12) Patent Application Publication
(10) Pub. No.: US 2009/0206616 A1
(43) Pub. Date: Aug. 20, 2009

(54) Auto vent stop

(76) Inventors: Luke Liang, South Plainfield, NJ (US); David Chen, Guangzhou (CN); Tong Liang, Foshan City (CN)

Correspondence Address: Thomas A. O'Rourke;Bodner & O'Rourke, LLP, Suite 108, 425 Broadhollow Road, Melville, NY, 11747, US

(21) Appl. No.: 12/381,148

(22) Filed: Mar. 6, 2009

Related U.S. Application Data
(63) Continuation-in-part of application No. 11/997,445, filed on Jan. 31, 2008.
Application No. 11/997,445 is a continuation-in-part of application No. 11/390,467, filed on Mar. 28, 2006, now Pat. No. 7,530,611.

(30) Foreign Application Priority Data
Aug. 1, 2005 (CN) 200510088643.7

(51) Int. Cl. E05C 17/44

(52) U.S. Cl. 292/338; 292/1

(57) ABSTRACT

A window vent stop for use in a sliding sash window assembly or a sliding door assembly. The vent stop has a housing adapted to be disposed in a recess in the non-movable sash member. This housing includes a cavity with a bottom plate therein. The tumbler has at least one pivot for pivotally securing the tumbler to the housing for movement between an extended position, to prevent movement of the sliding member and a retracted position, to allow movement of the sliding member. Also within the housing is a spring for biasing the tumbler. The housing has one or more flexible members extending from the end walls of the housing that secure the housing to an opening in a window sash when a portion of the window sash is positioned between the underside of a lip on said housing and the flexible member.

This application is a continuation in part of U.S. application Ser. No. 11/997,445, filed Oct. 24, 2007, which is a continuation in part of U.S. application Ser. No. 11/390/467, filed Mar. 28, 2006.

### FIELD OF THE INVENTION

The present invention is directed to the field of window hardware and, in particular, vent stops for preventing windows from opening more than a preset amount.

### BACKGROUND OF THE INVENTION

There has been an increase in interest in preventing falls by children aged five and under from open windows. There have been a number of window fall prevention devices on the market. These devices can include window opening control devices, window fall prevention screens and window guards. These devices use different strategies to prevent children from falling through an open window. Window opening control devices limit the amount a window may be opened by restricting the size of the open area of the window so that it is too small for a young child to fall through. These devices accomplish the limit to the opening by allowing the window to be set at a predetermined position. Window fall prevention screens and window guards provide a physical barrier to prevent a child from falling through an open window.

The Consumer Product Safety Commission has studied the issue and concluded that children under five are at risk of death or serious injury from falls through open windows. The Consumer Product Safety Commission has recommended that windows be open less than four inches to prevent falls. The four inch distance is drawn from building codes and standards for openings in guardrail assemblies. An additional operation is required to open the window further.

Current vent stops do not satisfy the criteria of another stop being required to open the window. Many of the current vent stops are designed to have two positions, an extended position that prevents window sash movement and a recessed position which permits movement. The current vent stops remain recessed when they are placed in that position and do not return to the extended position unless there is another step of releasing the stop. These current vent stops, therefore, do not satisfy the Consumer Product Safety Commission guidelines since they do not require a specific operation to open the window further. When the vent stop block is retracted, it remains retracted thereby permitting window sash movement.

Window opening control devices must also meet other requirements. For example, they must meet the force requirements set forth in ASTM F 2090. Window opening control devices must also be designed and installed so they will function properly during normal operation of the window to limit the opening area while maintaining structural integrity and durability. The release mechanism of the window opening control device must require less than 15 lbf. of force. To protect against inadvertent operation by a young child, the emergency escape release mechanism shall be operated either by two independent single actions or one dual action. Operation of the sash must be performed independently of operation of the release mechanism.

Vent stops allow user to partially open a window or door to allow air to flow. Window vent stops have a housing and a stop block portion that extends outwardly from the housing. The stop block is pivotably mounted in the housing to provide a first position for permitting at least one of the sashes of a window to slide freely. There is also a second position which causes the stop block to impinge against the other sashes to limit sliding movement.

There are a number of different types of window vent stops available on the market. An example of a window vent stop mechanism is shown in U.S. application Ser. No. 11/390,467, filed Mar. 28, 2007, the disclosures of which are herein incorporated herein by reference. These window vent stops are used to restrict the opening of windows and doors. For example, a window may be opened only a portion due to security concerns or to increase comfort in the room. Window vent stops are primarily used on double hung windows and sliding doors where a sash or a door member slides from a first position to a second position. The window sash lock prevents the sash or the sliding door from moving past a selected point. These sash locks can permit the window to be opened a desired amount for ventilation or other purposes.

Another type of vent stop is disclosed in U.S. patent application Ser. No. 11/977,445. In this vent stop there are flexible side engagement members to secure the housing to an opening in a window sash when a portion of the window sash is positioned between the underside of a lip or the housing and the flexible member.

Another type of vent stop is shown in U.S. Pat. No. 5,248,174 owned by Ashland Products. Still another stop is shown in U.S. Pat. No. 4,923,230 owned by Ashland. In each of these sash stops there is a spring biased tumbler or dog that pivots from an extended position to an unextended position. These vent stops are positioned in the frame of the upper sash and when the tumbler is pivoted outwardly the position of the tumbler prevents the lower sash from being raised above a preselected position. Other prior art patents for similar products are U.S. Pat. Nos. 5,553,903 and 5,806,900 both of which are owned by Ashland.

One particular problem encountered, however, by users of window vent stops is that product vent stops are designed so that the tumbler remains in a retracted position within the housing unless it is released and permitted to extend. These types of vent stops do not satisfy the ASTM standard F2090 because they have a recessed position that is locked in place. The only way the tumbler is placed in an extended position is if the tumbler is released. For example, in U.S. Pat. No. 5,248,174 the tumbler is retracted within the opening in the housing when it is desired to unlock the sash. By manually pushing the tumbler inwardly with the assistance of ribs on the tumbler the apex of the tumbler is disconnected from the protrusion. After disconnection, with continued pushing, the upper arcuate portion of the tumbler rotates past the protrusion until the tumbler is in a vertical position. From the vertical position the tumbler can be locked in a retracted position by moving the tumbler downward until the engagement portion contacts the face plate.

Thus, there is a need for vent stops that will satisfy the requirements of ASTM F2090. More specifically, there is a need for vent stops that automatically return to an extended position when the tumbler has been retracted into the housing.

### OBJECTS OF THE INVENTION

It is an object of the present invention to provide a vent stop that has a tumbler that automatically returns to an extended position when the tumbler is retracted into the housing.

It is another object of the present invention to provide an improved vent stop that does not lock the tumbler in the housing when the tumbler is retracted.

It is a further object of the present invention to provide a vent stop that satisfies the manipulation requirements of ASTM F2090.

It is still a further object of the invention to provide a vent stop where a spring in the housing extends the tumbler until such time as a force is extended on a top surface of the tumbler.

It is a further object of the present invention to provide a vent stop that provides a mechanism that permits the vent stop to be installed in a variety of different window types and sizes.

It is still another object of the present invention to provide a vent stop that is more flexible in its ability to fit into a variety of recesses carved into a sash stile.

It is still another object of the present invention to provide a vent stop that is more flexible in its ability to fit into a variety of recesses routed into a sash stile.

It is a still further object of the present invention to provide a vent stop that has flexible side engagement pieces which permit the vent stop to be installed in a variety of window types.

### SUMMARY OF THE INVENTION

The present invention is directed to an improved vent stop or sash lock for use in a sliding sash window assembly or a sliding door assembly. The window may have one or more sashes usually upper and lower sash window frames installed for vertical sliding movement. Alternatively, the window may have left and right horizontal sliding sashes. The door may also have one or more sliding doors. One sash frame or sliding door frame has a recess into the interior thereof. The vent stop has a housing adapted to be disposed in the recess.

This housing includes a cavity, usually with a bottom plate therein. Inside the cavity is a tumbler that may be in a retracted position and an extended position. When the tumbler is in an extended position the tumbler has a protruding apex at the top. The apex prevents a sash or door from moving when the apex contacts the sash or the door. The tumbler has at least one pivot means for pivotally securing said tumbler to said housing for movement between the extended position and the retracted position. In the extended position the bottom of the tumbler overlies a portion of the second sash to prevent movement of the lower sash past the tumbler. When in a retracted position within said cavity the sash or door can be raised and/or moved past the tumbler without interference. Also within the housing is a spring means for biasing said tumbler into the extended position. The tumbler has at least one means for retaining the tumbler within the housing. The retaining means may be one or more pins that extend laterally from the side of the tumbler and ride within an opening in the sidewall of the housing. Alternatively, the interior wall of the housing may have one or more pins extending toward the tumbler and riding within an opening in the tumbler's side wall.

The tumbler is normally in an extended position whereby a portion of the tumbler extends from the housing to prevent a sash from moving. The tumbler retracts into the housing when the force is removed. The tumbler returns to its extended position blocking movements of the sash.

The housing also has at least one side engagement piece, preferably two, which is preferably made from the same type of material as the housing and is flexible and bendable with the shape of the recess cut into the sash stile into which the window vent stop is placed. These side engagement pieces are intended to aid in the installation of the window vent stop into the sash stile and are flexible so as to enable the installation of the window vent stop in a wide variety of sash stiles of different sizes.

### BRIEF DESCRIPTION OF THE DRAWINGS

FIG. 1 is a side exploded view of a preferred embodiment of the vent stop of the present invention.

FIG. 2A is a side view of the vent stop of the present invention with the tumbler in an extended position.

FIG. 2B is a top view of the vent stop of FIG. 2A.

FIG. 2C is a bottom view of the vent stop of FIG. 2A.

FIG. 2D is an opposite side view of the vent stop of FIG. 2A.

FIG. 2E is a front end view of the vent stop of FIG. 2A.

FIG. 2F is a rear en view of the vent stop of FIG. 2A.

FIG. 2G is a perspective view of the vent stop of FIG. 2A.

FIG. 2H is a perspective view of the vent stop of FIG. 2D.

FIG. 3A shows the vent stop of the present invention partially inserted into an opening in a window sash.

FIG. 3B shows the vent stop inserted into the window opening.

FIG. 3C is a rear end view of the vent stop inserted into the window opening.

FIG. 4A shows the vent stop of the present invention partially inserted into an opening in a window sash of a lesser thickness.

FIG. 4B shows the vent stop inserted into the window opening for a sash of a lesser thickness.

FIG. 4C is a rear end view of the vent stop inserted into the window opening for a sash of a lesser thickness.

FIG. 5 is a top perspective view of the vent stop of FIG. 2A.

FIG. 6A shows a vent stop of the present invention with the tumbler extended in a normal position.

FIG. 6B shows the vent stop of FIG. 6A with the tumbler being partially recessed.

FIG. 6C shows the vent stop of FIG. 6A with the tumbler recessed.

FIG. 7 is a side exploded view of a preferred embodiment of the vent stop of the present invention.

FIG. 8A is a side view of the vent stop of the present invention with the tumbler in an extended position.

FIG. 8B is a top view of the vent stop of FIG. 8A.

FIG. 8C is a bottom view of the vent stop of FIG. 8A.

FIG. 8D is an opposite side view of the vent stop of FIG. 8A.

FIG. 8E is a front end view of the vent stop of FIG. 8A.

FIG. 8F is a rear en view of the vent stop of FIG. 8A.

FIG. 8G is a perspective view of the vent stop of FIG. 8A.

FIG. 8H is a perspective view of the vent stop of FIG. 8D.

FIG. 9A shows the vent stop of the present invention partially inserted into an opening in a window sash.

FIG. 9B shows the vent stop inserted into the window opening.

FIG. 9C is a rear end view of the vent stop inserted into the window opening.

FIG. 10A shows the vent stop of the present invention partially inserted into an opening in a window sash of a lesser thickness.

FIG. 10B shows the vent stop inserted into the window opening for a sash of a lesser thickness.

FIG. 10C is a rear end view of the vent stop inserted into the window opening for a sash of a lesser thickness.

FIG. 11 is a top perspective view of the vent stop of FIG. 8A.

FIG. 12A shows a vent stop of the present invention with the tumbler extended in a normal position.

FIG. 12B shows the vent stop of FIG. 12A with the tumbler being partially recessed.

FIG. 12C shows the vent stop of FIG. 12A with the tumbler recessed.

### DETAILED DESCRIPTION OF THE PRESENT INVENTION

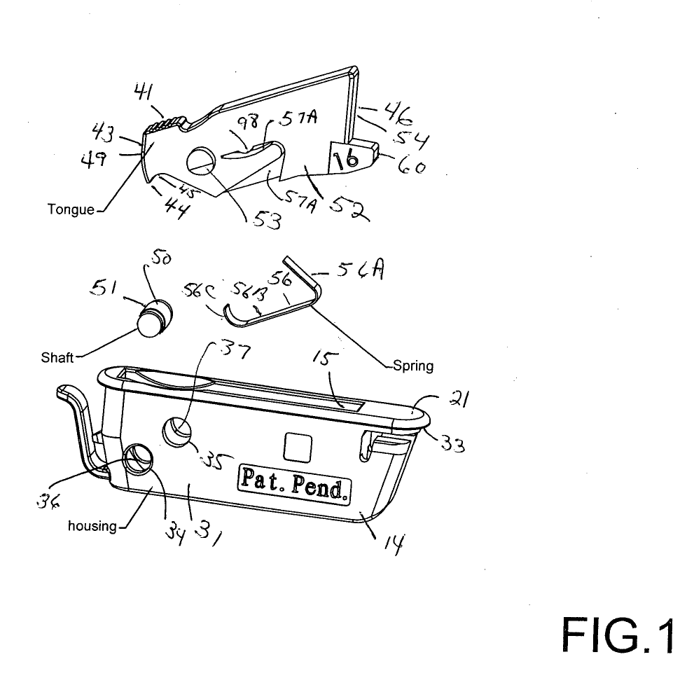

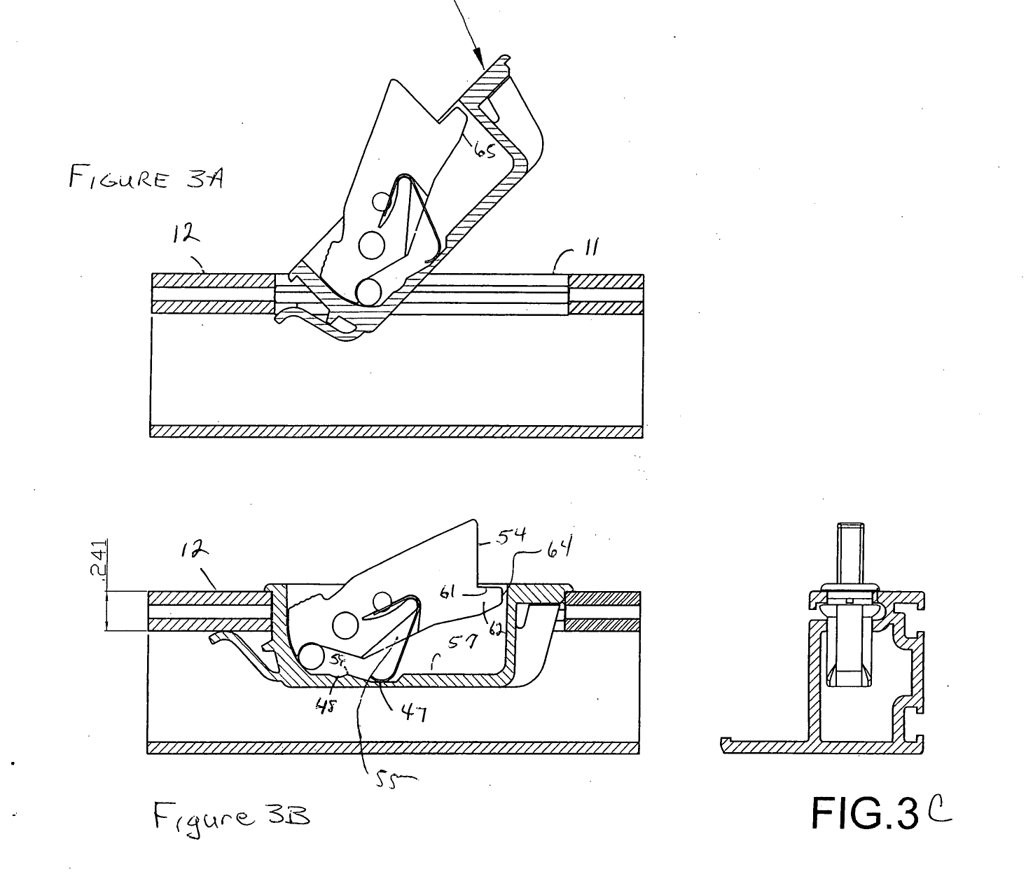

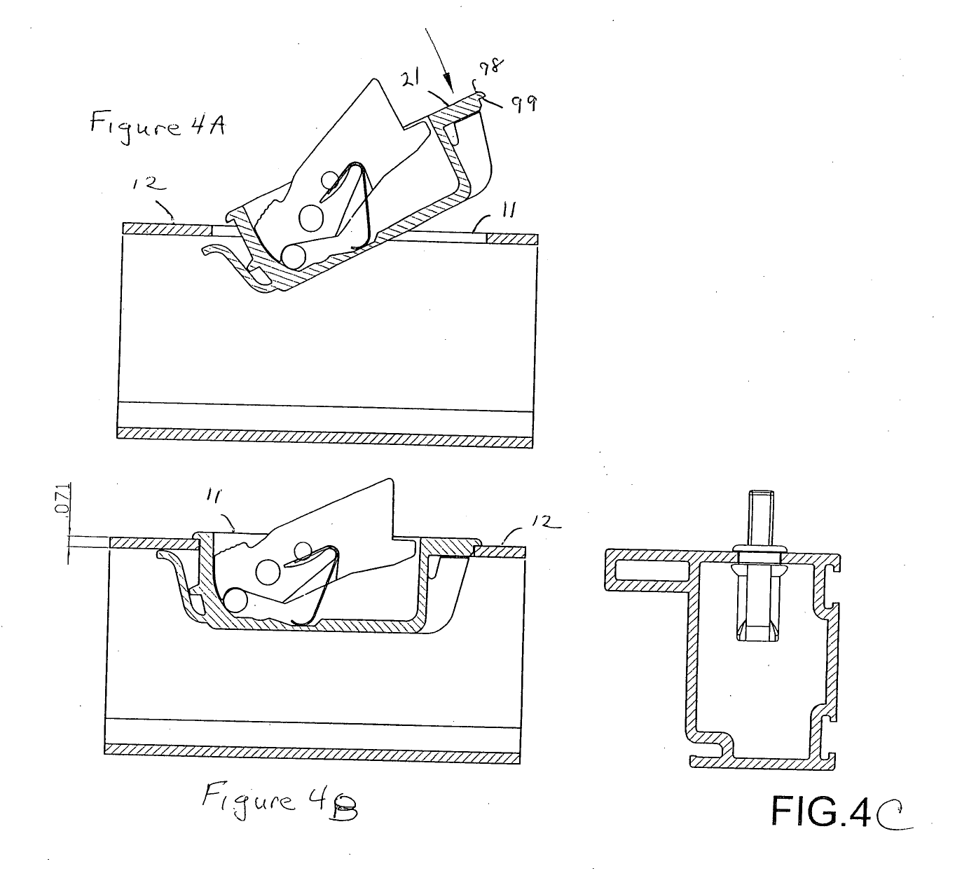

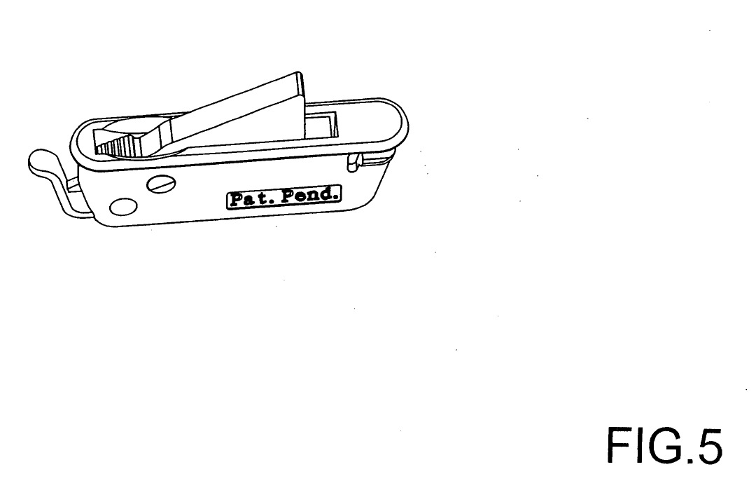

As seen in FIGS. 1 to 6, the window vent stop of the present invention is shown generally at 10. The vent stop 10 is shown for use in a slot 11 in sliding member, such as a window or door sash 12 as seen in FIGS. 3 and 4. The slot 11 may have an oval shape to receive the vent stop, but any other suitable shape and size slots including but not limited to a square, rectangle, oval, etc. can be used depending on the shape of the latch. Preferably, however, the vent stop 10 of the present invention will have a top surface with a flange extending outwardly of the top surface or other portion similarly shaped to the slot 11 as to present a clean appearance when placed in the window sash 12. In the present embodiment an oval shape for illustration purposes was used. The window sash can be a sash, doorframe, or any other member that has another piece sliding over it, where restriction of the window sash is desired. The tumbler 80 is normally in a raised position as opposed to prior art devices where the tumbler is locked in a retracted position and does not extend until released. When raised it prevents movement of the door or sash. The sash or door can move only when the tumbler is retracted manually and held in a retracted position. When the pushing force on the tumbler is removed, the spring in the housing causes the tumbler to become extended and, therefore, prevent movement of the sash. Thus, unless a force is placed on the tumbler, the tumbler is extended and prevents movement of the sash. In order to move the sash and open the window further, the tumbler must be kept in a recessed position by manual exertion on the tumbler forcing it into the housing. Two hands are needed to move the sash. One hand pushes on the tumbler and the other moves the sash. There is no lock mechanism that retains the tumbler in a recessed position in the housing.

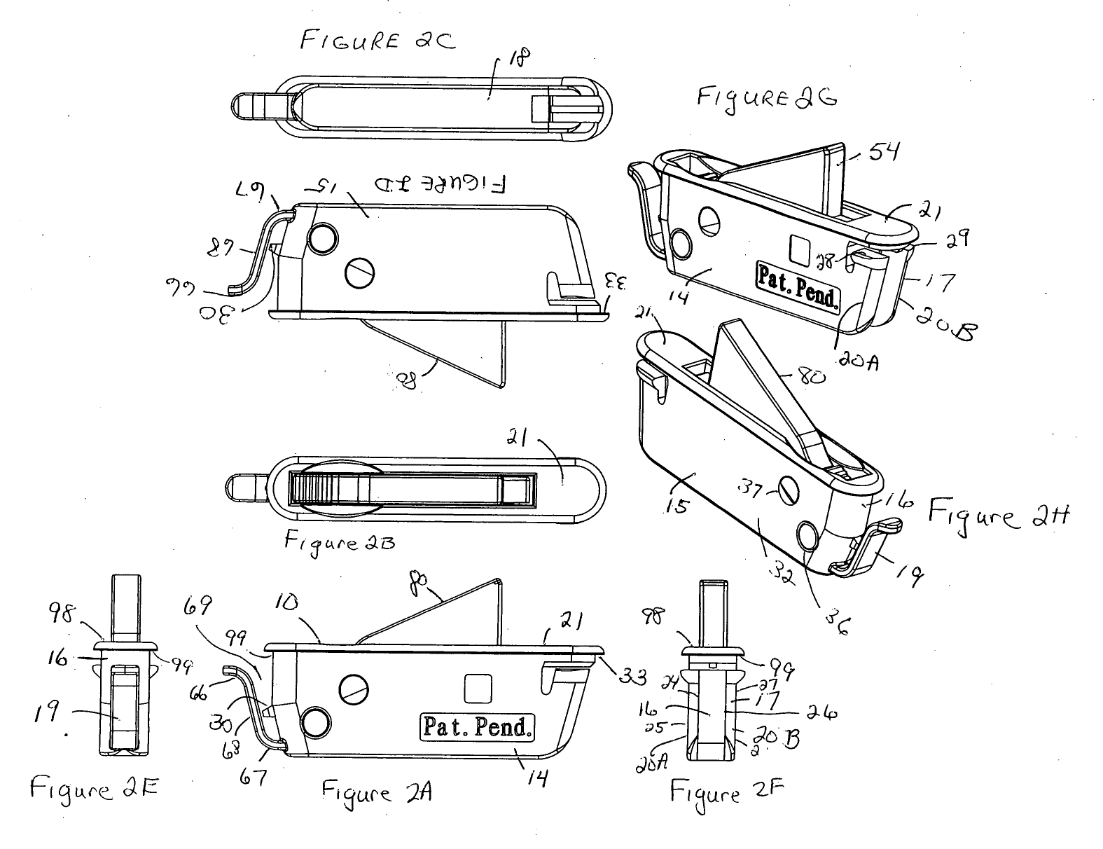

A housing 13 is generally defined by a first sidewall 14, and a second sidewall 15, and a front wall 16, and a rear wall 17, and a bottom wall 18, as shown in FIGS. 2A to 2H. Bottom wall 18 can also serve as a removable cover. In the present embodiment however, bottom wall 18 is sealed, and no removable cover is present. It is noted that the terms “front” and “rear” are used only for descriptive purposes and do not read on orientation of the device. Sidewalls 14, as seen in FIGS. 2A and 15 in FIG. 2D, are preferably the same length, width and height. Front and rear walls 16 and 17, respectively, have the same length, width and height, as well, providing for a generally rectangular shape to housing 13. Preferably, when in place within slot 11, sidewalls 14 and 15 contact the edges of slot 11 to provide for a tight fit, and prevent a lateral movement of the vent stop 10 within slot 11. There is also a top plate 21 that has a top surface 98 and an underside 99. The top surface 98 extends outwardly past the edge of the front and rear walls 16 and 17, creating a lip 33, as seen in FIGS. 2A and 2D. Front wall 16 and rear wall 17 can each have a flexible clip 19 and 20. In one embodiment of the present invention, there is only one flexible clip, first flexible clip 19. However, in the preferred embodiments, there are two clips, first flexible clip 19 and second flexible clip 20 which has two sections or clip portions 20A and 20B. The flexible clips 19 and 20 are preferably not identical, although, in alternate embodiments, they can be identical.

Either flexible clip 19 or 20 can be attached either front wall 16 or rear wall 17 depending upon a user's preference. As such it should be appreciated, that the embodiments illustrated in FIGS. 1 to 12 could easily be reversed and the first and second flexible clips 19 and 20 could be on the opposite wall 16 or 17. In one embodiment, illustrated in FIGS. 1 to 6, first flexible clip 20 can extend generally in an upward fashion, originating at or near the bottom surface 18 of housing 13 and ending typically just below top plate 21, as seen in FIG. 2G. In addition, flexible clip 20 may be solid or hollow. In one preferred embodiment flexible clip 20 is comprised of two generally rectangular protrusions, so as to resemble two teeth, tooth one 20A and tooth two 20B, as seen in FIG. 2G, located on sidewalls 14 and 15. Tooth one 20A has inner and outer surfaces 24 and 25, as seen in FIG. 2F, located adjacent to sidewall 14. Tooth two 20B has inner and outer surfaces 26 and 27, as seen in FIG. 2F, located adjacent to sidewall 15. Flexible clip 20 may be affixed to front wall 16 or flexible clip 20 may be an integral part of housing 13, in the present embodiment flexible clip 20 is an integral part of housing 13. In addition, flexible clip 20 has top surfaces 28 and 29, located on teeth 20A and 20B, respectively.

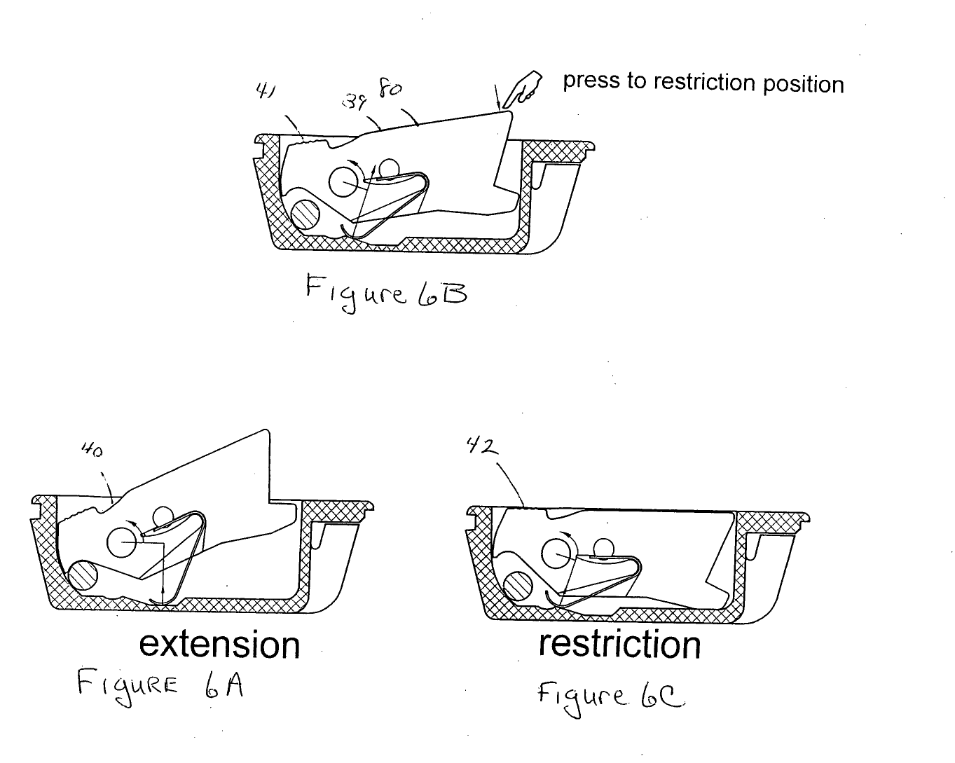

The second clip 19 ideally has more flexibility than the first clip 20, as seen in FIGS. 3A and 3B, and is adapted to grip the window sash 12 when a user attempts to install the vent stop, as shown in FIGS. 6 and 13. It may be located at the end of the housing 13. In this embodiment, the vent stop of the present invention can be more compatible with different style doorframes. For greater ease of installation, there is a tab 30 protruding from rear wall 17 of housing 13 as seen in FIG. 1, which ensures enough space between the clip and the housing 13. When the vent stop 10 is depressed into slot 11 on a window sash 12, the flexible clip 19 should be inserted sideling into slot 11 as seen in FIGS. 3 and 4. Flexible clips 19 and 20 can engage a portion of the window sash 12, as seen in FIGS. 3C and 4C. This engagement can prevent vertical (front and back) movement of the vent stop 10 within the window sash 12, as well as preventing the vent stop 10 from being easily dislodged from slot 11.

The shapes that second clip 19 could have are virtually endless, so long as the clip 19 maintains its flexibility while still possessing the ability to grip the window sash 12, to provide a clean installation of the vent stop 10. However, in one embodiment, the clip 19 preferably is “S”-shaped, characterized by curved upper and lower portions 66 and 67, each connected by a generally flat center portion 68, as shown in FIGS. 2A and 2D. In this embodiment, the lower portion 67 of the clip 19 preferably is connected to the rear wall 17 of the housing 13; nevertheless, the clip 19 could be secured to the housing 13 at any feasible point along the rear wall 17. The lower portion 67 of the clip 19 is arcuate, curving upward toward the flat center portion 68, creating an S-shaped clip, that strongly resembles the appearance of the “integral” sign in calculus. However, the bottom portion 67 could be curved in an opposite manner, or could even be flat, at an angle to the center portion 68 of the clip 19 in alternate embodiments. In another alternate embodiment, the clip 19 does not even have a lower portion and the center portion 68 extends diagonally outwardly from the rear wall 17 of the housing 13. The center portion 68 of the clip 19 extends diagonally outwardly from the lower portion 67, creating a gap 69 between it and the rear wall 17. This gap 69 allows the clip 19 to bend inwardly upon the installation of the vent stop 10. In alternate embodiments, however, the center portion 68 may extend straight in an upward direction from the lower portion 67 rather than outwardly. In other embodiments, the center portion 68 may be more S-shaped, with a portion that extends outwardly from the lower portion 67 and then inwardly toward the rear wall 17. Alternatively the distance the clip 19 maintains between it and the rear wall 17 may be adjustable based on the desired flexibility. The upper portion 66 of the clip 19 is a generally curved piece, arced in the opposite direction of the lower portion 68. But, in alternate embodiments it may be curved in a different direction, such as upward. The upper portion creates a lip or a flange 66, which has top and bottom surfaces 96 and 97. The top surface 96 of the lip 66 is where the window sash or other window sash 12 may rest when the vent stop is secured. The lip 66 of the second clip 20, along with the underside of the lip 33 of the top plate 21, act as a gripping mechanism holding the window sash in place. Although the lip 66 is generally short, equal in length to the lower portion 67, it may be longer or shorter as desired.

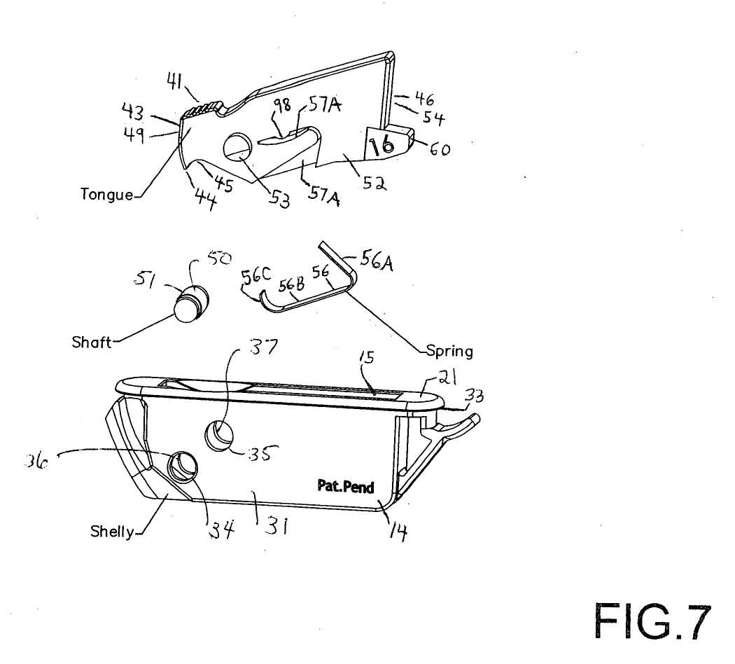

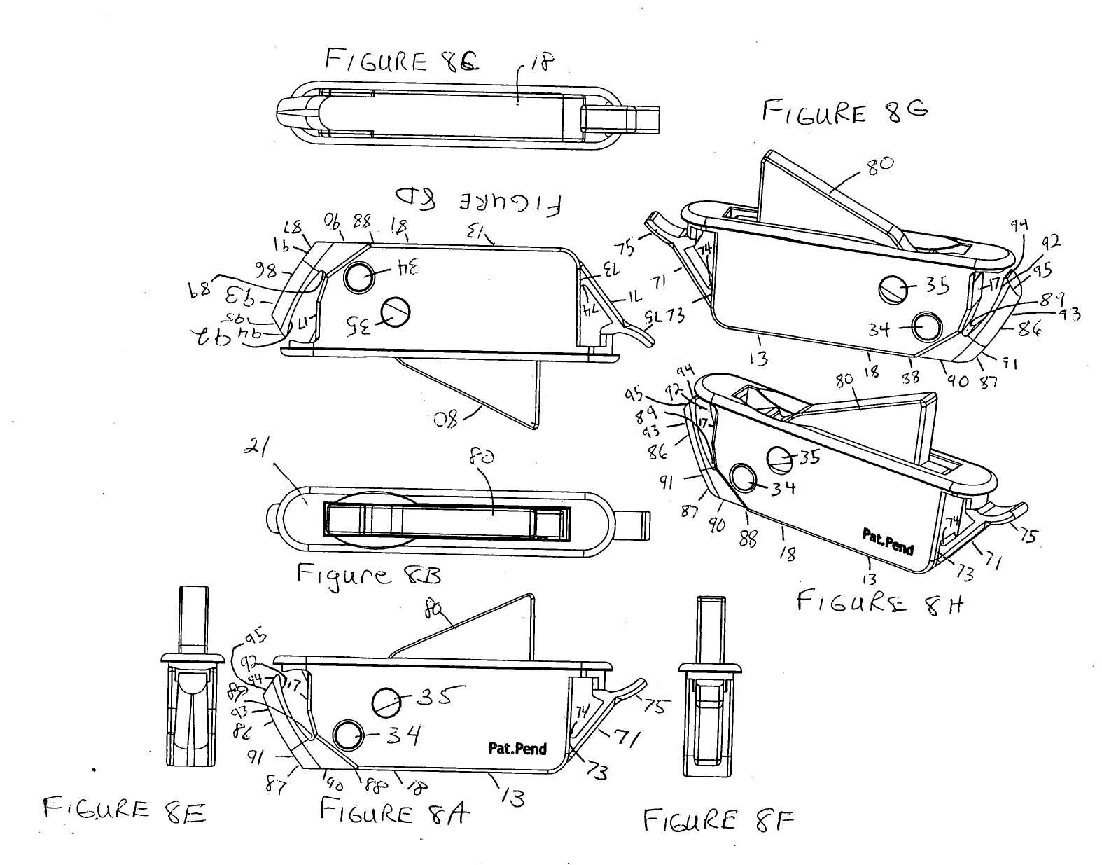

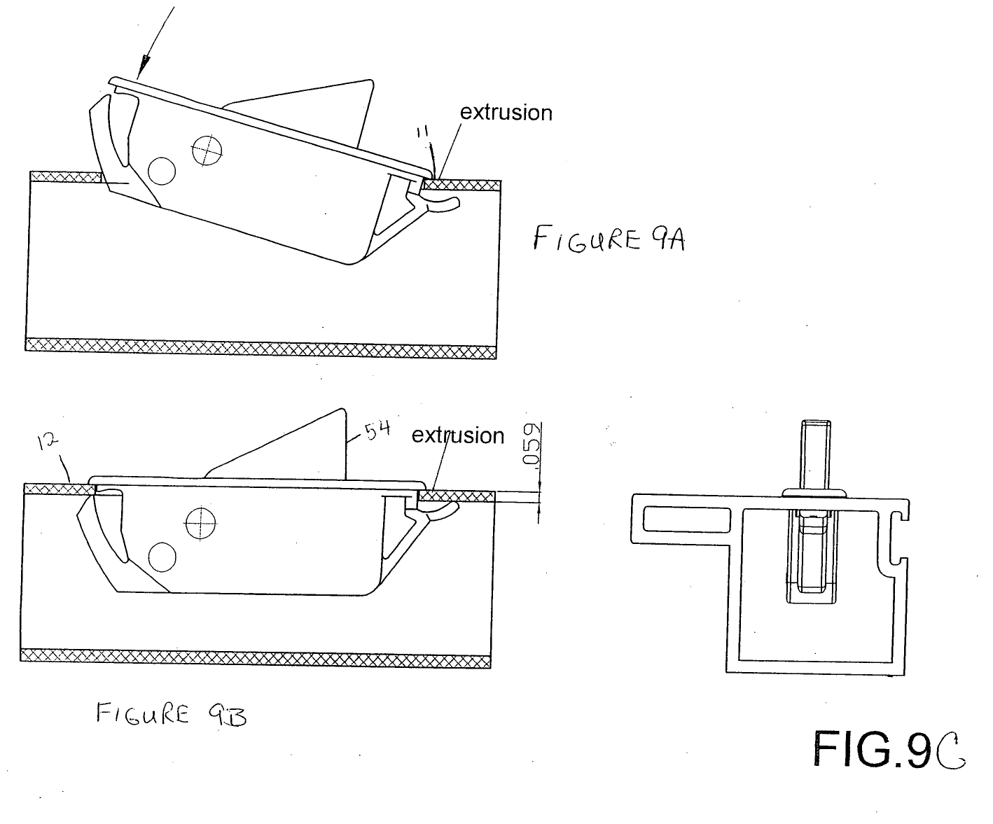

In another preferred embodiment, shown in FIGS. 7 to 12, the clip 20 has only one protrusion 86, which extends outwardly from the rear wall 17 of the housing 13. This embodiment of the first clip, is characterized by a protruding arm 86 and a base portion 87 connected to a recessed wall 88 situated between the rear wall 17 and the bottom wall 18 of the housing 13, as shown in FIG. 8A. The base portion has top and bottom surfaces 89 and 90 respectively, as well as a rear surface 91, which are all generally flat. Extending from the base portion 87 of the clip 20 is a single protruding arm 86, which is flexible and is at an angle with the rear wall 17. The arm 86 is generally rectangular, with an inner surface 92, an outer surface 93, a pointed upper surface 94 and a flat side surface 95, as shown in FIG. 8D. When the vent stop is slid into the slot 11 in the window sash 12, this embodiment of the clip will bend inwardly toward the rear wall 17, until the vent stop fits inside the slot. Once the vent stop 10 has been inserted, the protruding arm 86 will release back to its old position further away from the rear wall 17, with the window sash 12 being secured between the pointed upper surface 94 of the clip 20 and the lip 33 of the top plate 21, as shown in FIG. 9B. In alternate embodiments, the shape of the clip may be changed. For instance, the upper surface 94 does not have to be pointed, and the arm 86 can attach to the housing 13 at a different point along the rear wall 17. Additionally, a raised member, or tab could extend outwardly from the rear wall 17 so as to limit the amount of room the arm 86 has to move inward toward the rear wall 17. Essentially, any embodiment practicable to one in the art that would achieve the flexible support described above is possible.

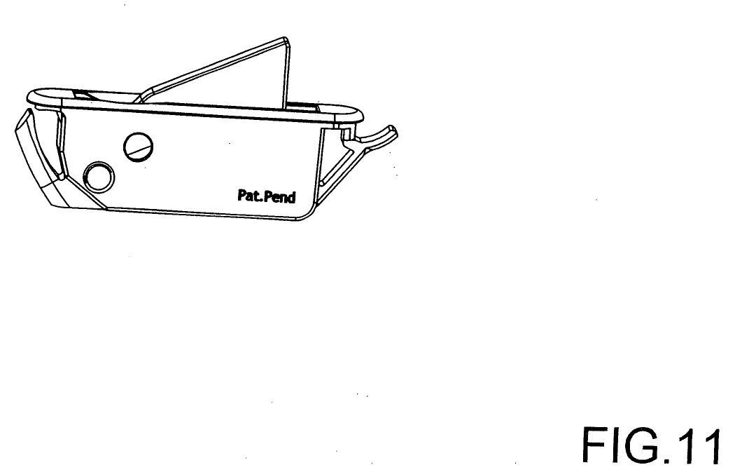

Another preferred embodiment of the clip 19 of the vent stop 10 of the present invention can also be seen in FIGS. 7 to 12. In this embodiment, the clip 19 comprises an arm 71 and a gripping mechanism 72, as shown in FIG. 11. The arm 71 generally has a base portion 73 that extends outwardly from the front wall 16, so that the arm 71 is diagonal to the surface of the front wall 16. In the present embodiment, this base portion 73 is generally characterized by a flat upper surface 74, and a bottom surface which is indistinguishable from the rest of the arm 71, as shown in FIG. 11. In alternate embodiments, the base portion 73 may be longer or curved, much like the lower portion 67 of the S-shaped clip 20 shown in FIGS. 1 to 6. The arm 71 is generally flat, although, in alternate embodiments, it may be curved as so desired. Extending from the top of the side opposite the base portion 73 of the arm 71 is the gripping mechanism 72 of the clip.

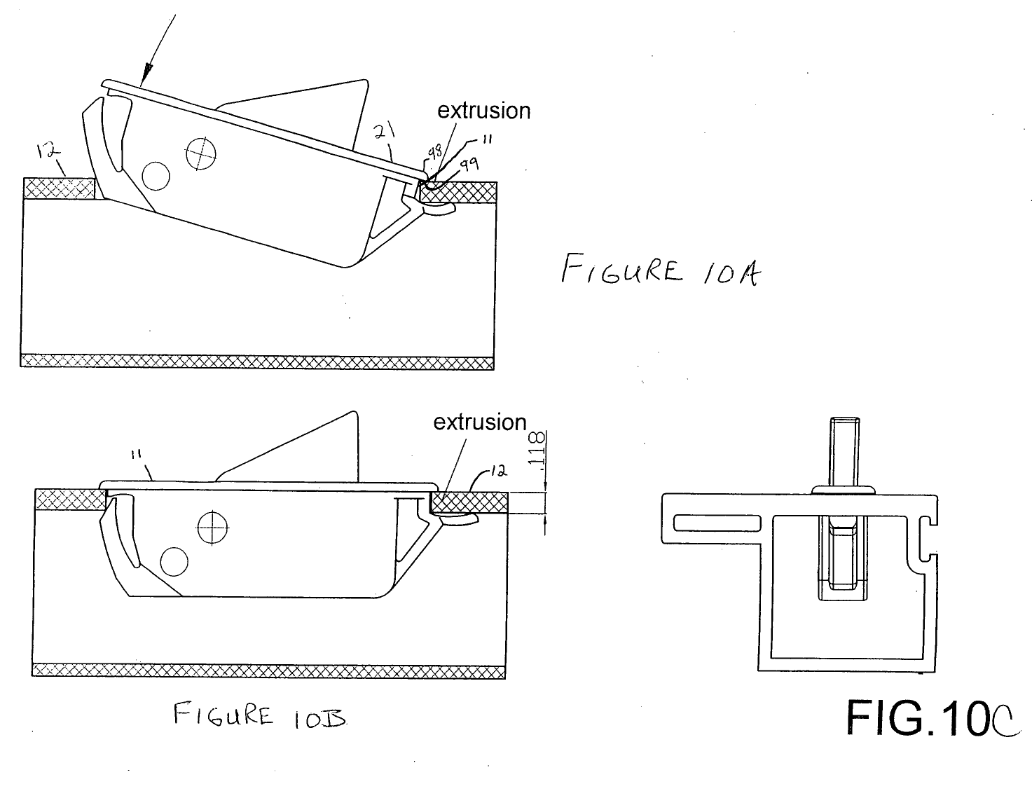

The gripping mechanism 72 comprises a protruding hook 75, a flat support surface 76 and a vertical retaining block 77. The protruding hook 75 extends outwardly from the top of the arm 71 of the clip 19, and it catches the window sash 12 and secures it to the vent stop 10. It is generally curved upward and has top and bottom surfaces 78 and 79 as well as a front surface 81, as shown in FIGS. 9 and 10. The window sash generally comes into contact with the top surface 78, where it comes to rest securely upon installation, as shown in FIGS. 9B and 10B. Although the hook 75 is generally curved, it could be flat in another embodiment, as the user desires. It may be curved in the opposite direction in another embodiment. The hook 75 is connected directly to a flat support surface 76, as shown in FIG. 11, the purpose of which is to further secure the window sash 12 to the vent stop 9 and 10. The support surface 76 comes into contact with a vertical retaining block 77, which has a front end 82 and a back end 83, as shown in FIGS. 9B and 10B. This retaining block 77 extends upwardly to the lip 33 of the top plate 21 on the rear end 83, and upwardly toward the underside 85 of an inner flange 84 running parallel to the top plate 21. The retaining block 77 further locks the window sash 12 in place in the clip 19. In various alternate embodiments, each of the various pieces 75, 76, and 77 of the gripping mechanism 72 may be removed. For instance, one embodiment might utilize the hook 75 and the support surface 76, but not the retaining block 77. Any arrangement that would safely secure the window sash 12 within the grip of the clip 19 that is practicable to one knowledgeable in the art is possible.

In alternate embodiments not yet illustrated a variety of configurations of clips 19 and 20 can be utilized. For instance, since the clip 19 requires only a gripping mechanism for holding the window sash 12 in place while the vent stop 10 is installed, any practicable gripping mechanism may be utilized. One example would simply by two protrusions extending outward from the wall of the housing, with no clip extending upward. One protrusion will fit underneath the window sash 12 and, the other, above it. For the other clip 20, in order to facilitate installation, the clip 19, as seen in FIGS. 7 to 12 could be concaved on both sides, creating an easier installation into the slot 11 and more flexibility. A final example of an alternate embodiment is if the clips 19 and 20 were on the sidewalls 14 and 15 of the housing 11 rather than the front wall 16 and rear wall 17. In this way, the vent stop 10 could be secured to the window sash 12 in a different manner.

First sidewall 14 has an inner surface, not shown, and outer surface 31, as seen in FIG. 1. Second sidewall 15 has inner surface and outer surface 32, as seen in FIG. 2H. On sidewalls 14 and 15 there can be four apertures, apertures 34 and 35 on sidewall 14, as seen in FIG. 1, and apertures 36 and 37 on sidewall 15, as seen in FIG. 2H. Apertures 34 and 36 of sidewalls 14 and 15, respectively, are aligned along the same central axis and are positioned towards rear wall 17, and are used to prevent tumbler 80 from rotating past a predetermined area and to support a substantial upward force associated with the lifting of the lower sash against the stopping surface of the latch. Apertures 35 and 37 of sidewalls 14 and 15, respectively, are also aligned along the same central axis; these apertures are designed so as to allow tumbler 80 to rotate in an outwardly fashion. In another embodiment one could implement pins aligned with bored cavities in the tumbler, aligned in a similar fashion, instead of apertures.

In yet another embodiment, sidewalls 14 or 15 may have at least one rotation member extending there from. In this type of embodiment tumbler 80 would have apertures or bored cavities aligned along the same central axis so as to allow tumbler 80 to rotate in an outwardly fashion.

A lip 33 is attached to top plate 21 is preferably at least the same size or larger and the same general shape as slot 11. Thus, when vent stop 10 is placed into slot 11, lip 33 will contact at least the edges of slot 11 or over spread the upper surface of the window sash 12. These dimensional attributes will allow for a tight fit that will exhibit a finished smooth exterior, which can be aesthetically pleasing. Although top plate 21 is referred to as a “plate”, it is understood that housing 13, clip 19, lip 33 and top plate 21 can be integral pieces, without any need for adhesives or assemblage.

In the preferred embodiment clip 19, attached to the rear of the housing, is preferably almost as high as the lower portion of the housing under the slot 11. Thus, when vent stop 10 is placed into slot 11, clip 19 will contact at least the edges of slot 11 or over spread the upper surface of the window sash 12. These dimensional attributes will allow for a tight fit that will exhibit a finished smooth exterior, which can be aesthetically pleasing. Although top plate 21 is referred to as a “plate”, it is understood that housing 13, clip 19, clip 20 and top plate 21 can be integral pieces, without any need for adhesives or assemblage.

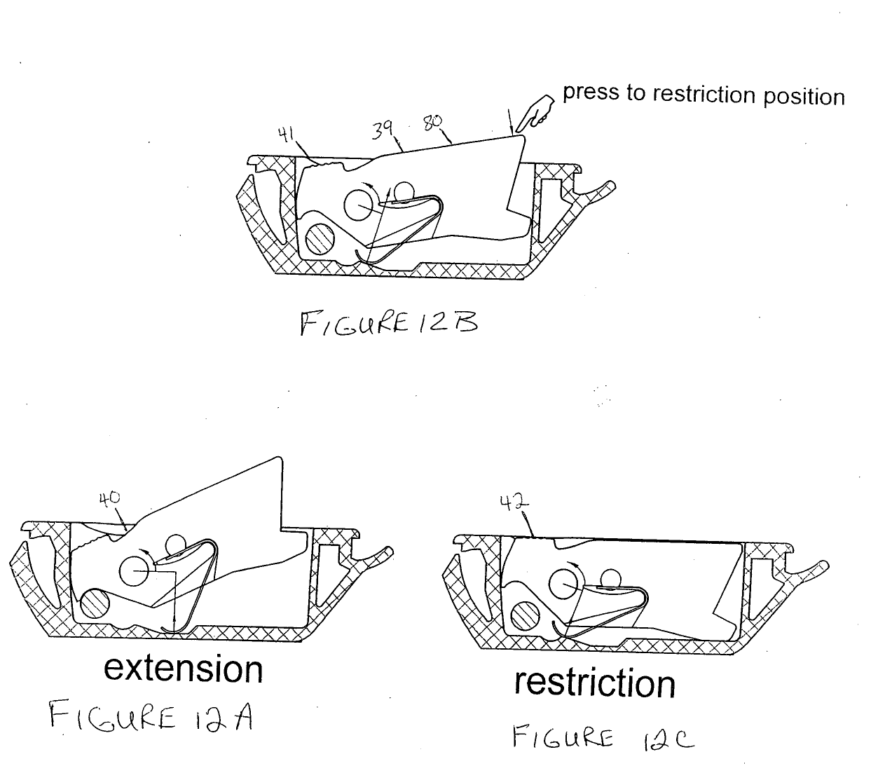

A tumbler 80 is preferably designed to fit within cavity 38 of housing 13, as seen in FIGS. 6C and 12C. Tumbler 80 may have an upper surface 39, which is preferably smooth and/or flat on the front portion, as seen in FIGS. 1 and 7. A flat surface 39 may exhibit a more finished look for the vent stop 10 when it is placed in window sash 12. Tumbler 80 may have an indent 40 located toward the rear top surface. In addition tumbler 80 may have a grooved top portion 41 located right adjacent indent 40, as in the present invention, which may act as a button 42, so as to allow the user to operate tumbler 80. The rear edge 43 of tumbler 80 slopes downward and comes to a point 44, where rear edge 43 meets arcuate bottom portion 45. Tumbler 80 can have a front end 46 and a rear end 49, along with side surfaces 52. Tumbler 80 can have rotation members 53, which can fit in apertures 35 and 37, of sidewalls 14 and 15 respectively, of housing 13. The rotation members 53 can be located on side surfaces 52, respectively, close to rear end 49. Preferably, rotation members 53 are cylindrical pegs, which protrude from side surfaces 52 of tumbler 80, respectively. The rotation members 53 can allow tumbler 80 to extend outwardly, thus exposing front end face 54 of tumbler 80, which would prevent movement of the window sash. The tumbler 80 will be allowed to rotate until surface 54 of tumbler 80 comes into contact with outer surface of a window sash. The window sash may be constructed of any type of material known in the art, but not limited to plastic, metal, wood, etc. Shaft 51 is secured in orifices 34 and 36 capable of withstanding the downward force of tumbler when the sash hits surface 54 of the tumbler. The window shaft 51 may be of any shape known in the art, but not limited to a cylindrical peg, a rectangular block, or a square peg. In the present embodiment a plastic cylindrical peg was implemented. Cylindrical peg 51, may be separate or an integral part of the housing, in the present embodiment cylindrical peg 51 is a separate member.

Tumbler 80 has a cavity 55 that houses a first portion the plate spring 56, as seen in FIGS. 1 and 7. However, this is not the only possible method of attaching a spring to tumbler 80. For example, tumbler 80 can have a protruding peg 98 on one or both of the side surfaces 52 that could hold the plate spring 56 in place. Tumbler cavity 55 has a first section 57A that has a top and bottom surface generally equal in width to plate spring 56 it houses. The length of the first section 57A is generally about the same length as the top surface portion 56A of the spring.

Plate spring 56 also has a bottom portion 56B that has a rounded tip 56C extending at the end of the bottom portion 56B residing in the second section 57B of tumbler cavity 55 which contacts the right arcuate nest 47 (as seen in the figure) and the left recession 48 in the inner bottom surface 57 of the housing 13 such that the tumbler is forced to a retracted position in the housing or an extended position out of the housing. In another embodiment rounded bottom portion 56C may be replaced by any angled shaped portion known in the art, which is capable of sliding. Inner bottom surface 57 of housing 13 has an arcuate nest 47 for cradling rounded bottom portion 58 of plate spring 56, as seen in FIG. 12. A divide point 59, where the right arcuate nest 47 meets the left recession 48. In normal operation the tumbler is normally in an extended position as shown in FIGS. 6A and 12A. This causes a window sash to be prevented from opening any further. This narrow window opening will be maintained and the sash can only be opened further if the tumbler is inserted into the housing by pressure on the top portion of the tumbler extending from the housing. Thus, the user must force tumbler 80 out of the normal raised position. The user will apply a downward, or inward force to the tumbler edge 39 will cause rounded bottom portion 56C of plate spring 56 to move out of arcuate nest 47 and pass the divide point 59 and move into the left recession 48 of bottom surface 57 of housing 13. One must point out that arcuate nesting portion 47, divide point 59, recession 48 of the bottom surface 57 and bottom rounded portion 58 of the plate spring 56 are of great consequence in the operation of this invention.

In addition to the tumbler cavity 55 of tumbler 80, there exists an arcuate surface 45 that interacts with an arcuate surface 50 of cylindrical peg 51. Arcuate surface 45 is preferably located on the rear bottom portion of tumbler 80. Tumbler 80 may have a protruding portion 60 located at the bottom front end wall of tumbler 80. The protruding portion 60 has a top surface 61 that extends perpendicularly from the front end face 54 of the tumbler 80. The protruding portion 60 also has a first side 62, as seen in FIGS. 3A and 3B, and a second side, not shown, a front face 64, and a bottom 65, as shown in FIGS. 3A and 3B. Bottom 65 of the protruding portion 60 extends outwardly in the same direction as top surface 61 so as to meet with the outside edge of front end face 64 and is parallel to the upper surface 39 so as to come into contact with the bottom surface of back wall 57 of the housing 13 and limit further rotation of the tumbler 80 in the housing 13 when the tumbler 80 is in the retracted position. The protruding portion 60 may be designed as to allow a meshing between the protruding portion 60 and the bottom surface of top plate 21, which would cause tumbler 80 from further rotating outwardly; thus if needed, protrusion 60 could be used as a limiting device.

The return of the tumbler 80 to the housing 13 to permit movement of a sash can be controlled by pressure on tumbler 80. Plate spring 56 slides along bottom surface 57 of the housing 13 and passes from right recession 47 over divide point 59 into left recession 48.

When the user wishes to activate tumbler 80, so as to prevent movement of a sliding window member, the user will release pressure on the tumbler surface 39 and an upward force caused by the spring moves curved portion 56 of the spring from left recession 48 to right recession 47. As long as downward pressure remains on the tumbler at surface 39, the tumbler will remain recessed. Once pressure is removed, the tumbler will automatically move to its extended position. When the force applied by the user has reached the critical point, it will cause the rounded bottom portion 56C of plate spring 56 to move out of equilibrium with right nesting area 47 of bottom surface 57 of housing 13 and slide across divide point 59 of bottom surface 57 of housing 13 and comes in the next equilibrium with left recession 48 of bottom surface 57 of housing 13. The critical point is reached when the force applied by the user overcomes the static frictional force, at which time bottom round portion 56C of plate spring 56 will begin to slide and the frictional force will drop back to a nearly constant value equal to that of the kinetic frictional force. When tumbler 80 is free to pivot on rotation members 53, the upward force of spring 56 will cause tumbler 80 to rotate in an outwardly direction until the rounded bottom portion 58 of plate spring 56 comes into contact with left recession 48 of bottom surface 57 of housing 13. In the same instance arcuate surface 45 of tumbler 80 will come in contact with arcuate surface 50 of cylindrical peg 51. In addition, a protruding portion 60 can also be implemented, so as to further limit movement of tumbler 80 by coming into contact with bottom surface of top plate 21. Once rounded bottom portion 58 of plate spring 56 has stopped sliding tumbler 80 will be exposed, thus preventing sliding window member from opening any further.

As various changes could be made in the above constructions without departing from the scope of the invention, it is intended that all matter contained in the above description shall be interpreted as illustrative and not in a limiting sense.

The operation of the vent stop according to the present invention will be obvious from the above description thereof.

I claim:

1. A vent stop for use in a sliding member comprising a housing and a tumbler that has an extended position wherein a portion of said tumbler extends from said housing and a retracted position wherein said tumbler is within said housing when a force is placed on a portion of the surface of said tumbler extending from said housing, said force causing said tumbler to retract into said housing, said tumbler returning to said extended position when said force is removed from said housing, said housing having a top plate, said top plate forming a lip with at least a portion of said housing, a first sidewall and a second sidewall, each of said sidewalls extending from said top plate and a front wall and a rear wall, each of said front and rear walls extending from said top plate and extending from said first sidewall to said second sidewall.

2. The vent stop according to claim 1 wherein said housing has a bottom surface extending from said first and second sidewalls, said bottom surface having an inner surface and an outer surface and wherein a spring secured to said tumbler contacts said bottom surface in a first position when said tumbler is in an extended position and a second position when said tumbler has a force exerted on it causing said tumbler to be retracted into said housing.

3. The vent stop according to claim 2 wherein said bottom surface that contacts said spring has a recess for receiving a portion of said spring when said tumbler is in a first position and a shallower recess when said tumbler is in a retracted position.

4. The vent stop according to claim 3 wherein said first recess on said bottom surface and said second recess on said bottom surface are separated by a divide point.

5. The vent stop according to claim 4 wherein said portion of said spring passes over said divide point when a force is placed on said tumbler causing said tumbler to be retracted into said housing.

6. The vent stop according to claim 5 wherein said portion of said spring passes from said second recess to said first recess and over said divide point when said force is removed from said tumbler, thereby said spring causing said tumbler to extend from said housing.

7. The vent stop according to claim 6 wherein one of said front and rear walls having a clip extending therefrom and wherein when said vent stop is inserted into a window sash a portion of said sash extends between said lip of said top plate and said clip.

8. The vent stop according to claim 7 wherein said clip is on said front wall.

9. The vent stop according to claim 7 wherein said clip is on said rear wall.

10. The vent stop according to claim 7 wherein said clip is flexible.

11. The vent stop according to claim 10 wherein said clip is generally “S”-shaped.

12. The vent stop according to claim 7 wherein one end of said clip is secured to one of said front and rear walls and the other end of said clip has a lip and wherein said window sash portion is between said lips when said stop is inserted in a window sash.

13. The vent stop according to claim 12 wherein said lip of said clip has a top surface and a bottom surface.

14. The vent stop according to claim 13 wherein said other of said front and rear walls has at least one tab extending therefrom.

15. The vent stop according to claim 14 wherein there is a first and second tab extending from said other of said front and rear walls.

16. The vent stop according to claim 14 wherein said tab extends outwardly from said other of said front and rear walls and has an outer surface in generally the same plane as one of said sidewalls.

17. The vent stop according to claim 15 wherein each tab extends outwardly from said other of said front and rear walls and has an outer surface in generally the same plane as each of the sidewalls.

18. The vent stop according to claim 14 wherein said clip is secured to said other of said front and rear walls at a location opposite said top surface.

19. The vent stop according to claim 7 wherein said top plate extends outwardly from said housing, said top plate having a top surface and an underside, said top plate having a retaining block extending from said underside.

20. The vent stop according to claim 19 wherein said clip has a hook and a flat support surface and where said support surface contacts said retaining block on the bottom surface of the top plate.

21. The vent stop according to claim 20 wherein said hook has a top surface and a bottom surface and wherein when said vent stop is positioned in a window, a portion of said window is between said top surface of said clip and the underside of said top plate.

22. A vent stop for use in a sliding member comprising a housing and a tumbler that has an extended position wherein a portion of said tumbler extends from said housing and a retracted position where said tumbler is within said housing, said tumbler being in an extended position until a force is placed on a top surface of said tumbler causing said tumbler to be retracted into said housing, said tumbler returning to said extended position when said force is removed from said tumbler, said housing having a top plate, said top plate forming a lip with at least a portion of said housing, a first sidewall and a second sidewall, each of said sidewalls extending from said top plate and said housing further comprising a front wall and a rear wall, one of said walls having a clip extending from said wall and wherein when said vent stop is inserted in slot in a window sash, a portion of said clip moves from a first position to a second retracted position toward said wall such that a portion of said window sash is positioned between the underside of said top plate and a surface of said clip.

23. The vent stop according to claim 22 wherein as said clip seeks to return to said first position a force exerted by said clip holds said vent stop in said slot in said window sash.

24. The vent stop according to claim 23 wherein said slot in said window sash has a sidewall extending from a top surface of said window sash and wherein said clip has an outer surface and an inner surface and wherein a portion of said outer surface of said clip contacts a portion of said sidewall of said slot in said window sash when said vent stop is in said slot in said window sash.

25. The vent stop according to claim 23 wherein said slot in said window sash has a sidewall extending from a top surface of said window sash and a bottom surface on an underside of a top surface of said window sash and where in said clip has an outer surface and an inner surface.
